(19) United States
(12) Patent Application Publication
(10) Pub. No.: US 2014/0266766 A1
(43) Pub. Date: Sep. 18, 2014

(54) SYSTEM AND METHOD FOR CONTROLLING MULTIPLE VISUAL MEDIA ELEMENTS USING MUSIC INPUT

(71) Applicant: Kevin Dobbe, Rochester, MN (US)

(72) Inventor: Kevin Dobbe, Rochester, MN (US)

(21) Appl. No.: 14/213,603

(22) Filed: Mar. 14, 2014

Related U.S. Application Data
(60) Provisional application No. 61/793,985, filed on Mar. 15, 2013.

(51) Int. Cl. G08B 5/00

(52) U.S. Cl. CPC G08B 5/00
USPC 340/691.8

(57) ABSTRACT

A system and method for controlling and manipulating visual media elements in direct response to sound input from controller instruments. When a controller instrument is played, it triggers a lighting, pictorial, or video response through the use of a synchronized interface between a computer and controlled visual hardware equipment sets. Display of lighting, pictorial, or video responses can be altered through the use of a multi-layer visual filtering process.

### CROSS-REFERENCE TO RELATED APPLICATION

This application claims the benefit of U.S. Provisional Application No. 61/793,985 filed Mar. 15, 2013, titled SYSTEM AND METHOD FOR CONTROLLING MULTIPLE VISUAL MEDIA ELEMENTS USING MUSIC INPUT.

### FIELD

The present invention generally relates to the ability of a system to control and manipulate visual media elements in direct response to sound input from controller instruments. More specifically, it relates to the ability for a musical instrument to trigger a lighting, pictorial, or video response when it, or a specific note from it, is played.

### BACKGROUND

The evolution of live entertainment has pushed the boundaries of audience expectation. Traditionally, live performances have included sound and visual components such as music, light, pictures, and video. Even while management of these individual components has become more complex, integration of these components in a performance has been a challenge. Therefore, there is a need for a system that allows the integration of different types of content that makes that content dynamic and fully interactive, such as control of visual media elements in direct response to audio input.

### BRIEF SUMMARY OF THE INVENTION

The present invention is both an implementation process and created software solution to control multiple visual media elements in direct response to music input from Musical Instrument Digital Interface (MIDI) controller instruments. MIDI is a technical standard that describes a protocol, digital interface, and connectors and allows a wide variety of electronic musical instruments, computers, and other related devices to connect and communicate with one another. The process synchronizes control of DMX lighting, video camera input, and standard or 3D-mapping video projection. DMX512 is a standard for digital communication networks that is used to control stage lighting and effects. The software solution is the synchronizing interface between the computer and the controlled visual hardware equipment sets, as well as a multi-layer visual filtering process that responds in real-time to the input from the MIDI controller by the musician.

The rationale for the creation of the process and software is the current lack of an industry unified control process. This new process allows performers in a musical ensemble to directly control multiple visual equipment sets in real-time. This process and software solution allows a performer to use traditional music notation to “play” multiple visuals from any commercially available MIDI and DMX standard equipment sets.

### BRIEF DESCRIPTION OF THE DRAWINGS

FIG. 1 illustrates one example of the implementation process of the disclosed system.

FIG. 2 illustrates one example of a video input/output interface.

FIG. 3 illustrates one example of a move-clip controls and FX interface.

FIG. 4 illustrates one example of a DMX lighting preset controls interface.

FIG. 5 illustrates one example of a picture overlay control interface.

FIG. 6 illustrates one example of a scene transport control interface.

FIG. 7 illustrates one example of an interface for a MIDI-controlled video synthesizer of images.

FIG. 8 illustrates one example of an interface for a MIDI-controlled video synthesizer of geometric shapes.

FIG. 9 illustrates one example of an interface showing the various regions of general control of the system as a whole.

FIG. 10 is a schematic block diagram depicting an example computing system used in accordance with one embodiment of the present invention.

FIG. 11 illustrates an image that demonstrates one example of a routine written to control mapping events.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

The software component of the system can be created in any computer language. For example, the system may use a visual programming language, such as Isadora, a proprietary graphic programming environment with emphasis on real-time manipulation of digital video. The software program consists of a large number of software routines that allow the following events: (1) a mapping of MIDI input to trigger designed presets for DMX controlled lights, camera input, and video output; (2) a mapping of MIDI input to trigger color mapping of pitch to color; (3) a mapping of MIDI input to trigger control of visual filtering of camera input images; (4) a mapping of MIDI input to trigger particle generators and other visual filtering routines that respond to dynamic of pitch played by the musician from the MIDI controller.

FIG. 11 is an image that demonstrates one example of the thousands of routines written to control the above-described events via the visual language Isadora. The programming language allows the use of the routines called actors. The analogue to this might be a programmer who has created a routine using the JavaScript language. The software solution segment disclosed herein is therefore not for the implemented software language, but rather the actor routines, examples of which are described herein.

The schematic of FIG. 1 shows one example of the implementation process disclosed herein. The implementation process can be achieved with the integration of the software program used in, for example, a laptop 102 via commands from the DMX interface 104 or MIDI interface 106 to lighting equipment, 108 or it can be implemented via MIDI communication from the software program to any commercially available lighting software programs that are designed to receive MIDI communication. In the example illustrated in FIG. 1, the program can trigger lighting cues at exact moments in time via the musician on stage. The system could also control commercially produced visual filtering software, such as control via the MIDI interface 106 over an application designed for real time video mixing and compositing that is implemented by, for example, a computer on stage left 110 and/or a computer on stage right 112.

The disclosed process and software includes a MIDI interface 106 between multiple MIDI-input devices that is connected to at least one computer, such as a laptop 102, running the software. The connected, commercially available MIDI-input devices have two primary purposes: (1) Handling Procedure-One (HP-1): to send preset cues to control all connected media (video, lights, sound, etc.), and (2) Handling Procedure-Two (HP-2): to control video effects directly related to the MIDI input of the musician. The disclosed system and method allows for the creation of a potentially unlimited number of visual parameters that can be controlled by the musician.

A typical implementation usage could consist of a musician playing two MIDI keyboards incorporating both HP-1 and HP-2 methods. In one embodiment, the first keyboard (HP-1 based) would create no sound, but would be used to cue the presets of all connected media. For example, the musician following a traditional music score written for the selected music might play a “low-C” on beat three of measure 25. When doing so, the preset of light cues and video can change precisely at that moment in time, thus allowing the synchronization of the media to be controlled by a musician responding to the leadership of the conductor of the ensemble. That one note can be assigned to control hundreds of stationary and moving lights. All parameters of lights and video can be controlled and synchronized.

In one embodiment, the second keyboard (HP-2 based) could be used as a controller with no sound (or other MIDI-input device) or a MIDI device creating sound and could be used to control visual aspects of projects and directly relate to the music being performed. Each note can be assigned a specific color, image, filter, etc. and the dynamics of each note played can also control media. For example, if a musician were to play “middle-C”, the preset might cause a blue oval to appear on the video output. The dynamic played by the musician might be assigned to the intensity of the color. Therefore allowing the image to change in intensity directly related to the intensity played by the musician.

The software component of the system can be used in two primary manners: (1) Implementation Procedure-One (IP-1): As a “plug-and-play” software that is written for specific music compositions, and/or (2) Implementation Procedure-Two (IP-2): As a programming software allowing musicians to create their own presets for any piece of music.

In the first case, where the software is used as “plug-and-play” (IP-1), predesigned software is implemented for a specific music selection. All visual and light cues are written to synchronize to the music composition, and an accompanying music score is included with the software. In that case, the computer, lights, video, and connected MIDI controllers are setup as diagramed by the authors (generally by a technical person or crew). The musician would then simply following the created musical score for the composition and all visual media elements would be synchronized to the music composition, such as Beethoven's Symphony no. 5.

In the second case of the usage of software (IP-2), the musician could use the software interface to create his or her own media cues. A simple selection process interface allows a very complex series of visual manipulations to be created by the user of the software. FIGS. 2, 3, and 4 illustrate examples of the Video and Lights control interface in the disclosed system.

The connected components to the software consist of two primary categories: (1) Input Control Devices (ICD) 114, and (2) Output Control Devices (OCD). All ICD 114 and OCD devices are commercially available hardware that connect to the software on, for example, a laptop 102 via commercially available interface devices such as MIDI interfaces 106 and DMX interfaces 104.

The software component of the system can communicate with any commercially available ICD 114. The most common form of ICD 114 is a MIDI keyboard. MIDI keyboards can be sound-producing or non-sound-producing. MIDI keyboards, such as an acoustic piano that also accepts MIDI data in and out, can be connected to the software. Other contemporary forms of ICD's 114 can be connected to control OCD's. Those type of ICD's 114 include commercially available wind controllers and percussion controllers as well as other types of controllers for guitar, among many others.

The software component of the system can communicate with any commercially available OCD. The primary categories of OCD's include: (1) DMX-controlled lighting/Camera systems, (2) Video projection systems and Projection Mapping, (3) Video processing systems, and (4) Sound production systems.

The software component of the system allows light systems to be controlled from any connected ICD 114 in two primary manners: (1) Preset Cue Control (PCC), and (2) Direct Light Control (DLC).

Preset Cue Control (PCC) is designed to change large lighting cues that can be triggered by the touch of a single note from any connected ICD 114. Any commercially available DMX software program that receives MIDI commands for light cues can be connected to the disclosed software. In general, a multi-light scene is designed in a connected commercially available software program and is assigned a MIDI-note number. That number is then assigned to a cue in the disclosed software that has a specific pitch assignment. When the cue is to be played, that specific note is represented in the music notation and is “played” by the musician reading the music score, thus triggering a complex lighting scene at an exact moment in time with the touch of a single note from the connected ICD 114.

Direct Light Control (DLC) allows a mapping of a particular note on an ICD 114 to map to a particular light. Each note can be assigned a specific color. For instance, all C's can be assigned “Red,” all F sharps can be assigned “Blue,” and so on. The color assigned can be predetermined if the software is being used in the IP-1 mode. Alternatively, the user can assign the color if the software is being used in the IP-2 mode. The software expresses the “loudness” of each note by raising or lowering the intensity of the light. For example, if a musician plays a C quietly, the corresponding light can illuminate at less lumens than if the note is played loudly. The brightness level is from 0-127, where 0 equals note off and where 127 represents the brightest setting of the light.

The software component of the system allows camera PTZ (Pan/Tilt/Zoom) camera systems to be controlled from any connected ICD 114. When a PTZ camera is connected to the system, presets of cameras can be triggered. For example, a camera cue focusing on the conductor can be set as cue-1, a close-up of the concertmaster can be set to cue-2, and so on for as many camera cues as desired. This allows hundreds of camera cues to be triggered at exact moments in time. For example, if the brass section is featured at a given moment in time, the cue for that setting can be “played” by the musician playing the ICD 114 at an exact moment in time. The camera(s) assigned can be predetermined if the software is being used in the IP-1 mode. Alternatively, the user can assign camera(s) if the software is being used in the IP-2 mode.

DMX-controlled cameras can be used on any or all of the video input cues. Traditional stationary cameras located throughout the performance space can also be interspersed with the video input. The software component can use any number of camera inputs as desired by the design of programmer. As before, an ensemble might choose to use a program that is already designed (IP-1 mode) or may choose to design his or her own camera input triggers when using the IP-2 mode of the software.

The software component of the system allows the cameras, and all connected media and filters, to be projected in any number of outputs via commercially available equipment. A single data projector or multiple monitors and video mapping projectors can be connected to the software. This allows the video aspect of the program to be scalable to the needs of the presenters.

In one embodiment, the system allows six individual, synchronized video outputs, which permits one screen or projection area to be assigned different visual data than another screen or projection area. For example, a center screen or projection area above the orchestra can display images of the performing musicians as input from any of the multiple cameras. An additional screen or projection area might be the translation of the text by the singers involved. Another screen or projection area might be the visual interpretation of the solo piano being played and interpreted in real-time from the MIDI output of that piano to the interpreting the software program. A further screen or projection area might be still images or movie loops that respond to the amplitude of the musicians. The number of design possibilities allows each performance to be unique.

The projections assigned can be predetermined if the software is being used in the IP-1 mode or they can be assigned by the user if the software is being used in the IP-2 mode. The output mode of the projections can use all contemporary standards for video output, ranging from standard video setting such as “640×480” resolution to HD.

The software component of the system allows projection mapping as an output option. This permits the video output to be projected on irregularly shaped surfaces such as, but not limited to, rounded walls and concert hall balcony areas. Therefore, any surface can be a potential projection area that can be controlled by the musicians on the stage.

The software component of the system allows thousands of video processing options of any input. The input could be the camera input showing the live performers, a still image or movie clip, or text. Each of those elements can be filtered for aesthetic ends. The program offers hundreds of potential filters such as simple color changes to very complex alterations. These filters are plugins that are commercially available. The filters assigned can be predetermined if the software is being used in the IP-1 mode, or can be assigned by the user if the software is being used in the IP-2 mode.

In addition to simple video filtering, the software includes video processing plugins (VPP) that make each note of a connected MIDI ICD 114 have a particular visual automation. The visual automations can change depending upon what note is played, how loud that note has been played, and so on, to create a synchronized visual event that responds to each note that is performed by the musician. The VPPs that are assigned to each note can be predetermined if the software is being used in the IP-1 mode, or can be assigned by the user if the software is being used in the IP-2 mode.

The software component of the system allows assigned sounds to be performed in conjunction with all of the previously discussed visual controls. The performers can use the software to control, in real time, commercially available synthesizers and sound events. Multiple audio outputs can be assigned to allow sounds to emanate from any area. For example, sounds can come from any area of the stage and any location in the performance space such as, but not limited to, a balcony. The audio outputs assigned can be predetermined if the software is being used in the IP-1 mode, or can be assigned by the user if the software is being used in the IP-2 mode.

The technical specifications of the software will fluctuate relative to the advancements in computational processing. As commercially available computers, cameras, video boards, etc. continue to advance, the total number of media input and output parameters can change to reflect the industry standards. The following are general technical specifications: (1) Simultaneous HD-video inputs, each of which can be connected to a switcher camera (selection of which can be automated) with multiple video inputs, thus allowing an unlimited number of video inputs; (2) HD-video outputs; (3) Control of multiple DMXs; (4) Simultaneous audio outputs; (5) Multiple MIDI input/output ports, each of which allows several channels; (6) Control of Pan/Tilt/Zoom of all video camera inputs; (7) Many real-time video effect filters; (8) Many MIDI to Video routines; (9) OSC (Open Sound Control) incorporation of control of hardware/software; and (10) An unlimited number of scene cues.

The following are the general software control specifications, as illustrated in FIG. 9, but these specifications can change to incorporate advantages of advancements of industry standards: (1) Video input/output, as illustrated in FIG. 2, (2) Movie-clip controls and FX, as illustrated in FIG. 3, (3) DMX lighting preset controls, as illustrated FIG. 4, (4) Scene transport controls, as illustrated in FIG. 5, (5) Picture overlay controls, as illustrated in FIG. 6, (6) MIDI controlled video synthesizer of images, as illustrated in FIG. 7, (7) MIDI controlled video synthesizer of geometric shapes, as illustrated in FIGS. 8, and (8) Scene location indicator 902.

FIG. 2 illustrates the video input/output interface. The software permits control of multiple camera inputs and allows for multiple simultaneous live video inputs. Further, because a commercially produced video switcher can be connected to each video input with multiple camera-input connects and the switchers can be controlled by the software, the system allows for virtually any number of camera inputs with preset controls for each scene.

Each video camera can be “colorized” using a color gradient 202 with the interface showing the video coloring before the color gradient 202 is applied 204 and after the color gradient 202 is applied 206. Each video camera can also be set to a mix with the other video inputs that are described further below. Additionally, the video can be assigned a trigger number 208, so that it is displayed at the proper time during a performance.

Each video input can be assigned to a particular “stage” or video output as described below. The parameters of this area are recalled as “snapshots” for each scene selected by the controller of the software. The section can be predetermined if the software is being used in the IP-1 mode, or can be assigned by the user if the software is being used in the IP-2 mode.

The move-clip controls and FX interface of the software, as illustrated in FIG. 3, allows the control of movie clips/video files 302 that can be assigned and mixed with visual FX to any of the video output sections. Thousands of video clips can be loaded and assigned to any particular scene and can be altered with visual FX and mixed for instant recall for each scene. Additionally, the video can be altered through changes such as, but not limited to, speed 304, stage selection 306, transparency 308, intensity 310, magnification 312, and color gradient 314. In FIG. 3, the selected movie clip/video file can be displayed on its own 316 and overlaying video input 318. The interface can be predetermined if the software is being used in the IP-1 mode, or can be assigned by the user if the software is being used in the IP-2 mode.

FIG. 4 illustrates the DMX lighting preset controls interface. DMX-controlled light presets can control any connected commercially available software program. Each scene can control several universes of DMX lighting installation. The presenters, who are incorporating the disclosed software, can determine the number of lights. Each lighting scene is instantaneously recalled as each scene is entered via the specified note played by the musician controlling the software. Within the lights interface, as illustrated in FIG. 4, the user can select which light color will be displayed by designating the instrument(s) or voice(s) responsible for the trigger. The section can be predetermined if the software is being used in the IP-1 mode, or can be assigned by the user if the software is being used in the IP-2 mode.

FIG. 6 illustrates a scene transport control interface. This interface permits a user to select a particular scene 602 and dictate how quickly that scene should fade in 604 and fade out 606. An unlimited number of cues can be created to control all media for each scene. A scene consists of all the media presets determined, and the scene can be predetermined if the software is being used in the IP-1 mode, or can be assigned by the user if the software is being used in the IP-2 mode.

Any type of MIDI controller, such as, but not limited to, a keyboard, percussion, or wind controller, can be connected to the disclosed software. Each MIDI controller can be assigned to a particular MIDI port. When that controller “plays” a particular note, a specific scene can then be triggered. The fade-in 604/out 606 can be assigned for each scene for desired effect.

A musician can read a music-notation score that indicates the exact moment that each scene is to be triggered. This allows the synchronization of all media to be ultimately cued by the conductor of any ensemble. This control can be done with one MIDI controller. Additional MIDI controllers can be connected to the software to create instantaneous video synthesizer effects.

FIG. 5 illustrates a picture overlay control interface. A user can select pictures 502 to use and can alter those pictures through changes such as, but not limited to, color gradients 504, intensity 506, magnification 508, perspective 510, position on a screen 512, width/height 514, stage selection 516, transparency 518, and layering 520. Any number of images can be assigned to any stage, mixed, and/or assigned to any video output. Each image can be altered via color, placement, and numerous visual effects. Texts can be projected and assigned to any of the six output sections. Each preset is saved as a preset to any cue and is instantaneously triggered at each scene. The section can be predetermined if the software is being used in the IP-1 mode, or can be assigned by the user if the software is being used in the IP-2 mode.

FIG. 7 illustrates an interface for a MIDI-controlled video synthesizer of images. A user can select pictures 702 to use and can alter those pictures through changes such as, but not limited to, size 704, color 706, surface position 708, X gravity 710, Z gravity 712, absorption 714, and rotation 716. Additionally the user can alter where the pictures are displayed by selecting a port 718, channel 720, layer 722, additive effect 724, stage 726, show/hide effect 728, and vertice 730. The video synthesizer can be controlled by a second, or multiple, additional MIDI controllers. Each scene can be assigned a different visual mapping set. The mapping visual can be a static picture or a movie file.

Each note that is played by the musician creates a specific visual that is relative to the note played and the loudness of each note. Hundreds of animations can be assigned to each note. Animations can include particle generators that can be controlled via presets for each scene. This allows each note performed to be synchronized to, and represent, a specific visual effect. The section can be predetermined if the software is being used in the IP-1 mode, or can be assigned by the user if the software is being used in the IP-2 mode.

FIG. 8 illustrates an interface for a MIDI-controlled video synthesizer of geometric shapes. Similar to the control of images, the software, through an independent visual synthesizer, can generate an array of different geometric shapes that can be assigned any color and location with multiple visual effects. A user can select geometric shapes 802 to use and can alter those shapes through changes such as, but not limited to, layering 804, transparency 806, and line width 808. Each note can be assigned a specific color and location to visualize the dynamics and pitch of each note. The section can be predetermined if the software is being used in the IP-1 mode, or can be assigned by the user if the software is being used in the IP-2 mode.

The Scene Location Indicator 902 section indicates what particular scene is being triggered at that moment in time. Each scene can be assigned to a note of the primary MIDI controller. For example, the lowest note on a piano, low A, can be assigned to scene-1 of Movement-1. The next note up on a piano, low B flat, can be assigned to scene scene-2 of Movement-1, and so on. This allows 88 different scenes for each movement.

Any number of Movements can be written thus allowing an unlimited number of scenes that can be triggered depending upon the design for each particular music composition or performance. The section can be predetermined if the software is being used in the IP-1 mode, or can be assigned by the user if the software is being used in the IP-2 mode.

The disclosed invention involves technology that uses a computing system. FIG. 10 is a schematic block diagram of an example computing system 1000. The invention includes at least one computing device 1002. In some embodiments the computing system further includes a communication network 1004 and one or more additional computing devices 1006 (such as a server).

Computing device 1002 can be, for example, located in a musical performance venue. In some embodiments, computing device 1002 is a mobile device. Computing device 1002 can be a stand-alone computing device or a networked computing device that communicates with one or more other computing devices 1006 across a network 1004. The additional computing device(s) 1006 can be, for example, located remotely from the first computing device 1002, but configured for data communication with the first computing device 302 across a network 1004.

In some examples, the computing devices 1002 and 1006 include at least one processor or processing unit 1008 and system memory 1012. The processor 1008 is a device configured to process a set of instructions. In some embodiments, system memory 1012 may be a component of processor 1008; in other embodiments system memory is separate from the processor. Depending on the exact configuration and type of computing device, the system memory 1012 may be volatile (such as RAM), non-volatile (such as ROM, flash memory, etc.) or some combination of the two. System memory 1012 typically includes an operating system 1018 suitable for controlling the operation of the computing device, such as the OS X operating system or the WINDOWS® operating systems from Microsoft Corporation of Redmond, Wash., or a server, such as one employing OS X or Windows SharePoint. The system memory 1012 may also include one or more software applications 1014 and may include program data 1016.

The computing device may have additional features or functionality. For example, the device may also include additional data storage devices 1010 (removable and/or non-removable) such as, for example, magnetic disks, optical disks, or tape. Computer storage media 310 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media is non-transitory media.

In some examples, one or more of the computing devices 1002, 1006 can be located in a performance center or auditorium. In other examples, the computing device can be a personal computing device that is networked to allow the user to access the present invention at a remote location, such as in a user's home, office or other location. In some embodiments, the computing device 1002 is a smart phone, tablet, laptop computer, personal digital assistant, or other mobile computing device. In some embodiments the invention is stored as data instructions for a smart phone application. A network 1004 facilitates communication between the computing device 1002 and one or more servers, such as an additional computing device 1006, that host the system. The network 1004 may be a wide variety of different types of electronic communication networks. For example, the network may be a wide-area network, such as the Internet, a local-area network, a metropolitan-area network, or another type of electronic communication network. The network may include wired and/or wireless data links. A variety of communications protocols may be used in the network including, but not limited to, Wi-Fi, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 1006 is a Web server. In this example, the first computing device 1002 includes a Web browser that communicates with the Web server to request and retrieve data. The data is then displayed to the user, such as by using a Web browser software application. In some embodiments, the various operations, methods, and functions disclosed herein are implemented by instructions stored in memory. When the instructions are executed by the processor of one or more of the computing devices 1002 and 1006, the instructions cause the processor to perform one or more of the operations or methods disclosed herein. Examples of operations include synchronization of lighting, video camera input, and video projection, and other operations.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

I claim:

1. A method of controlling and manipulating visual media elements in response to sound input from controller instruments comprising:
utilizing a networked computing device having a processing device and a memory device, the memory device storing information that, when executed by the processing device, causes the processing device to:
accept instructions to trigger the display of a visual media element when a specific input is received;
receive input from a controller instrument;
send an activation cue to display the visual media element; and
synchronize the output of an activation cue with the receipt of input.

2. The method of claim 1, wherein the controller instrument is a musical instrument digital interface controller instrument.

3. The method of claim 1, wherein the input is a musical note played by the controller instrument.

4. The method of claim 3, wherein the brightness of the displayed visual media element corresponds to the intensity of the musical note played by the controller instrument.

5. The method of claim 1, wherein the visual media element is a video recording.

6. The method of claim 5, wherein the video recording is processed through the use of at least one filter.

7. The method of claim 1, wherein the visual media element is a light.

8. The method of claim 1, wherein the visual media element is an image.
